(19) United States
(12) Patent Application Publication
(10) Pub. No.: US 2019/0156834 A1
(43) Pub. Date: May 23, 2019

(54) VEHICLE VIRTUAL ASSISTANCE SYSTEMS FOR TAKING NOTES DURING CALLS

(71) Applicant: Toyota Motor Engineering & Manufacturing North America, Inc., Erlanger, KY (US)

(72) Inventors: Scott A. Friedman, Dallas, TX (US); Prince R. Remegio, Lewisville, TX (US); Tim Uwe Falkenmayer, Mountain View, CA (US); Roger Akira Kyle, Lewisville, TX (US); Ryoma Kakimi, Ann Arbor, MI (US); Luke D. Heide, Plymouth, MI (US); Nishikant Narayan Puranik, Frisco, TX (US)

(73) Assignee: Toyota Motor Engineering & Manufacturing North America, Inc., Erlanger, KY (US)

(21) Appl. No.: 15/821,150

(22) Filed: Nov. 22, 2017

(51) Int. Cl. G10L 15/26; G10L 25/48; G10L 15/20; G06F 3/16; H04M 3/22; G10L 13/04

(52) U.S. Cl. CPC G10L 15/265; G10L 25/48; G10L 15/20; G10L 2015/228; H04M 3/2218; G10L 13/043; G06F 3/167

(57) ABSTRACT

A vehicle virtual assistance system for taking a note is provided. The vehicle virtual assistance system includes one or more processors, one or more memory modules communicatively coupled to the one or more processors, a microphone communicatively coupled to the one or more processors, wherein the microphone receives acoustic vibrations, and machine readable instructions stored in the one or more memory modules. The vehicle virtual assistance system initiates a call, receives, from a party of the call, a voice request for taking the note during the call, initiates a note taking function in response to receiving the voice request, and stores voice input from the party as a first note.

### TECHNICAL FIELD

Embodiments described herein generally relate to vehicle virtual assistance systems and, more specifically, to vehicle virtual assistance systems for taking notes during calls

### BACKGROUND

Occupants in a vehicle may interact with a speech recognition system of the vehicle. The speech recognition system may receive and process speech input and perform various actions based on the speech input. Speech recognition systems may include a number of features accessible to a user of the speech recognition system. For example, occupants may place a call, play music, turn on the radio, etc. However, occupants may be limited to interact with the speech recognition system during a call with another party, and may not be able to take a note while driving.

Accordingly, a need exists for a speech recognition system that takes notes while an occupant in a vehicle is on a call.

### SUMMARY

In one embodiment, a vehicle virtual assistance system for taking a note is provided. The vehicle virtual assistance system includes one or more processors, one or more memory modules communicatively coupled to the one or more processors, a microphone communicatively coupled to the one or more processors, wherein the microphone receives acoustic vibrations, and machine readable instructions stored in the one or more memory modules. The vehicle virtual assistance system initiates a call, receives, from a party of the call, a voice request for taking the note during the call, initiates a note taking function in response to receiving the voice request, and stores voice input from the party as a first note.

In another embodiment, a vehicle includes a microphone configured to receive acoustic vibrations, and a vehicle virtual assistance system communicatively coupled to the microphone. The vehicle virtual assistance system includes one or more processors, one or more memory modules communicatively coupled to the one or more processors, and machine readable instructions stored in the one or more memory modules. The vehicle virtual assistance system initiates a call, receives, from a party of the call, a voice request for taking a note during the call, initiates a note taking function in response to receiving the voice request, and stores voice input from the party as a first note.

In yet another embodiment, a method for taking notes includes initiating a call, receiving, through a microphone of a virtual assistance system, a voice request for taking notes during the call from a party of the call, initiating a note taking function of the virtual assistance system in response to receiving the voice request, receiving voice input from the party of the call, and storing the voice input as a note.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an interior portion of a vehicle for providing speech recognition system status notifications, according to one or more embodiments shown and described herein;

FIG. 2 schematically depicts a speech recognition system, according to one or more embodiments shown and described herein;

FIG. 3 depicts a flowchart for taking a note during a call, according to one or more embodiments shown and described herein;

FIG. 4A depicts initiating a note taking function, according to one or more embodiments shown and described herein; and

FIG. 4B depicts providing a note that had been taken during a call, according to one or more embodiments shown and described herein.

### DETAILED DESCRIPTION

The embodiments disclosed herein include vehicle virtual assistance systems for taking notes. Referring generally to the figures, embodiments of vehicle virtual assistance systems for taking notes are provided. The vehicle virtual assistance system includes one or more processors, one or more memory modules communicatively coupled to the one or more processors, a microphone communicatively coupled to the one or more processors, wherein the microphone receives acoustic vibrations, and machine readable instructions stored in the one or more memory modules. The vehicle virtual assistance system initiates a call, receives, from a party of the call, a voice request for taking the note during the call, initiates a note taking function in response to receiving the voice request, and stores voice input from the party as a first note. When the call is terminated, the vehicle virtual assistance system reminds the party of the note, and takes action that is described in the note. With the help of the vehicle virtual assistance system, the user of the vehicle is able to take notes while she is on a call and driving in the vehicle. In addition, the other party of the call may also take notes for the user of the vehicle during the call. Furthermore, the vehicle virtual assistance system combines notes from more than one party of the call such that a party of the call is provided with a consolidated note for the call. The various vehicle virtual assistance systems for taking notes will be described in more detail herein with specific reference to the corresponding drawings.

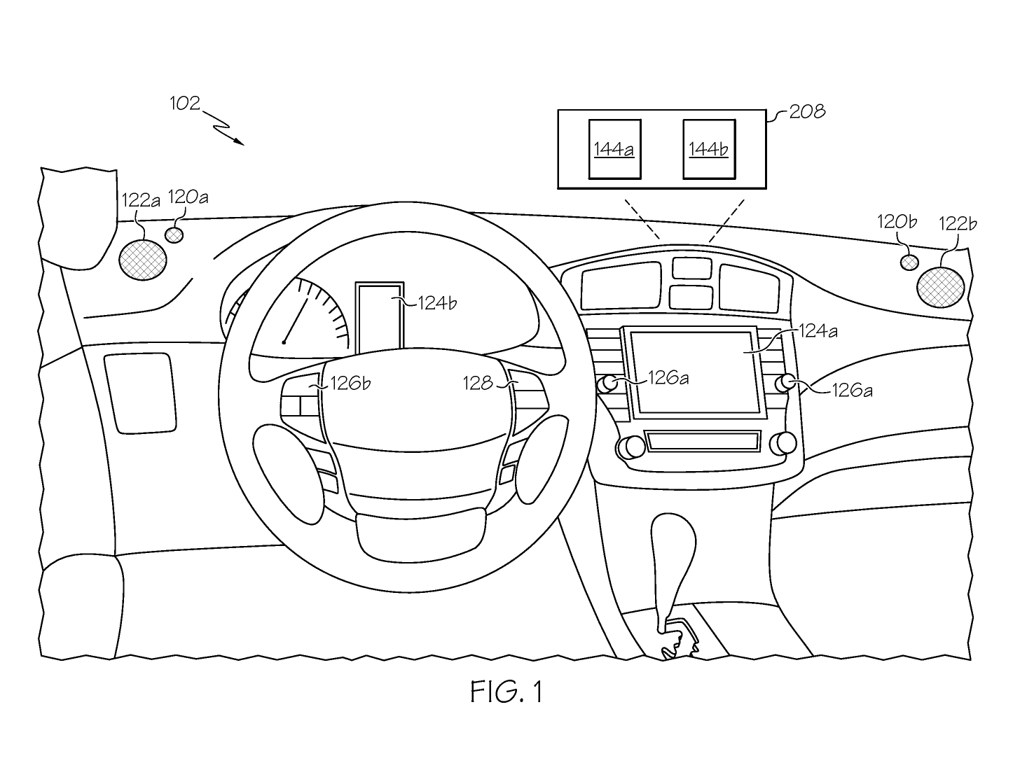

Referring now to the drawings, FIG. 1 schematically depicts an interior portion of a vehicle 102 for providing virtual assistance, according to embodiments disclosed herein. As illustrated, the vehicle 102 may include a number of components that may provide input to or output from the vehicle virtual assistance systems described herein. The interior portion of the vehicle 102 includes a console display 124a and a dash display 124b (referred to independently and/or collectively herein as “display 124”). The console display 124a may be configured to provide one or more user interfaces and may be configured as a touch screen and/or include other features for receiving user input. The dash display 124b may similarly be configured to provide one or more interfaces, but often the data provided in the dash display 124b is a subset of the data provided by the console display 124a. Regardless, at least a portion of the user interfaces depicted and described herein may be provided on either or both the console display 124a and the dash display 124b. The vehicle 102 also includes one or more microphones 120a, 120b (referred to independently and/or collectively herein as “microphone 120”) and one or more speakers 122a, 122b (referred to independently and/or collectively herein as “speaker 122”). The microphone 120 may be configured for receiving user voice commands and/or other inputs to the vehicle virtual assistance systems described herein. Similarly, the speaker 122 may be utilized for providing audio content from the vehicle virtual assistance system to the user. The microphone 120, the speaker 122, and/or related components may be part of an in-vehicle audio system. The vehicle 102 also includes tactile input hardware 126a and/or peripheral tactile input 126b for receiving tactile user input, as will be described in further detail below. The vehicle 102 also includes an activation switch 128 for providing an activation input to the vehicle virtual assistance system, as will be described in further detail below.

The vehicle 102 may also include a virtual assistance module 208, which stores voice input analysis logic 144a, and response generation logic 144b. The voice input analysis logic 144a and the response generation logic 144b may include a plurality of different pieces of logic, each of which may be embodied as a computer program, firmware, and/or hardware, as an example. The voice input analysis logic 144a may be configured to execute one or more local speech recognition algorithms on speech input received from the microphone 120, as will be described in further detail below. The response generation logic 144b may be configured to generate responses to the speech input, such as by causing audible sequences to be output by the speaker 122 or causing imagery to be provided to the display 124, as will be described in further detail below.

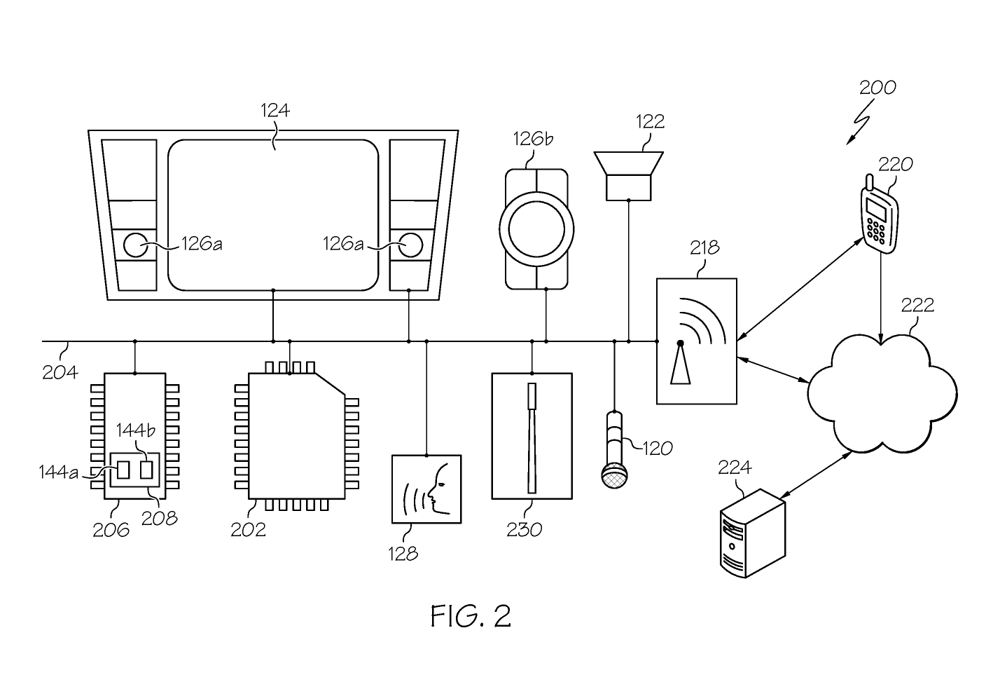

Referring now to FIG. 2, an embodiment of a vehicle virtual assistance system 200, including a number of the components depicted in FIG. 1, is schematically depicted. It should be understood that the vehicle virtual assistance system 200 may be integrated with the vehicle 102 or may be embedded within a mobile device (e.g., smartphone, laptop computer, etc.) carried by a driver of the vehicle.

The vehicle virtual assistance system 200 includes one or more processors 202, a communication path 204, one or more memory modules 206, a display 124, a speaker 122, tactile input hardware 126a, a peripheral tactile input 126b, a microphone 120, an activation switch 128, a virtual assistance module 208, network interface hardware 218, and a satellite antenna 230. The various components of the vehicle virtual assistance system 200 and the interaction thereof will be described in detail below.

As noted above, the vehicle virtual assistance system 200 includes the communication path 204. The communication path 204 may be formed from any medium that is capable of transmitting a signal such as, for example, conductive wires, conductive traces, optical waveguides, or the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 204 communicatively couples the various components of the vehicle virtual assistance system 200. As used herein, the term “communicatively coupled” means that coupled components are capable of exchanging data signals with one another such as, for example, electrical signals via conductive medium, electromagnetic signals via air, optical signals via optical waveguides, and the like.

As noted above, the vehicle virtual assistance system 200 includes the one or more processors 202. Each of the one or more processors 202 may be any device capable of executing machine readable instructions. Accordingly, each of the one or more processors 202 may be a controller, an integrated circuit, a microchip, a computer, or any other computing device. The one or more processors 202 are communicatively coupled to the other components of the vehicle virtual assistance system 200 by the communication path 204. Accordingly, the communication path 204 may communicatively couple any number of processors with one another, and allow the modules coupled to the communication path 204 to operate in a distributed computing environment. Specifically, each of the modules may operate as a node that may send and/or receive data.

As noted above, the vehicle virtual assistance system 200 includes the one or more memory modules 206. Each of the one or more memory modules 206 of the vehicle virtual assistance system 200 is coupled to the communication path 204 and communicatively coupled to the one or more processors 202. The one or more memory modules 206 may comprise RAM, ROM, flash memories, hard drives, or any device capable of storing machine readable instructions such that the machine readable instructions may be accessed and executed by the one or more processors 202. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules 206. In some embodiments, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

In embodiments, the one or more memory modules 206 include the virtual assistance module 208 that processes speech input signals received from the microphone 120 and/or extracts speech information from such signals, as will be described in further detail below. Furthermore, the one or more memory modules 206 include machine readable instructions that, when executed by the one or more processors 202, cause the vehicle virtual assistance system 200 to perform the actions described below. The virtual assistance module 208 includes voice input analysis logic 144a and response generation logic 144b.

The voice input analysis logic 144a and response generation logic 144b may be stored in the one or more memory modules 206. In embodiments, the voice input analysis logic 144a and response generation logic 144b may be stored on, accessed by and/or executed on the one or more processors 202. In embodiments, the voice input analysis logic 144a and response generation logic 144b may be executed on and/or distributed among other processing systems to which the one or more processors 202 are communicatively linked. For example, at least a portion of the voice input analysis logic 144a may be located onboard the vehicle 102. In one or more arrangements, a first portion of the voice input analysis logic 144a may be located onboard the vehicle 102, and a second portion of the voice input analysis logic 144a may be located remotely from the vehicle 102 (e.g., on a cloud-based server, a remote computing system, and/or the one or more processors 202). In some embodiments, the voice input analysis logic 144a may be located remotely from the vehicle 102.

The voice input analysis logic 144a may be implemented as computer readable program code that, when executed by a processor, implements one or more of the various processes described herein. The voice input analysis logic 144a may be a component of one or more processors 202, or the voice input analysis logic 144a may be executed on and/or distributed among other processing systems to which one or more processors 202 is operatively connected. In one or more arrangements, the voice input analysis logic 144a may include artificial or computational intelligence elements, e.g., neural network, fuzzy logic or other machine learning algorithms.

The voice input analysis logic 144a may receive one or more occupant voice inputs from one or more vehicle occupants of the vehicle 102. The one or more occupant voice inputs may include any audial data spoken, uttered, pronounced, exclaimed, vocalized, verbalized, voiced, emitted, articulated, and/or stated aloud by a vehicle occupant. The one or more occupant voice inputs may include one or more letters, one or more words, one or more phrases, one or more sentences, one or more numbers, one or more expressions, and/or one or more paragraphs, etc.

The one or more occupant voice inputs may be sent to, provided to, and/or otherwise made accessible to the voice input analysis logic 144a. The voice input analysis logic 144a may be configured to analyze the occupant voice inputs. The voice input analysis logic 144a may analyze the occupant voice inputs in various ways. For example, the voice input analysis logic 144a may analyze the occupant voice inputs using any known natural language processing system or technique. Natural language processing may include analyzing each user's notes for topics of discussion, deep semantic relationships and keywords. Natural language processing may also include semantics detection and analysis and any other analysis of data including textual data and unstructured data. Semantic analysis may include deep and/or shallow semantic analysis. Natural language processing may also include discourse analysis, machine translation, morphological segmentation, named entity recognition, natural language understanding, optical character recognition, part-of-speech tagging, parsing, relationship extraction, sentence breaking, sentiment analysis, speech recognition, speech segmentation, topic segmentation, word segmentation, stemming and/or word sense disambiguation. Natural language processing may use stochastic, probabilistic and statistical methods.

The voice input analysis logic 144a may analyze the occupant voice inputs to determine whether one or more commands and/or one or more inquiries are included in the occupant voice inputs. A command may be any request to take an action and/or to perform a task. An inquiry includes any questions asked by a user. The voice input analysis logic 144a may analyze the vehicle operational data in real-time or at a later time. As used herein, the term “real time” means a level of processing responsiveness that a user or system senses as sufficiently immediate for a particular process or determination to be made, or that enables the processor to keep up with some external process.

Still referring to FIG. 2, the vehicle virtual assistance system 200 comprises the display 124 for providing visual output such as, for example, information, entertainment, maps, navigation, information, or a combination thereof. The display 124 is coupled to the communication path 204 and communicatively coupled to the one or more processors 202. Accordingly, the communication path 204 communicatively couples the display 124 to other modules of the vehicle virtual assistance system 200. The display 124 may include any medium capable of transmitting an optical output such as, for example, a cathode ray tube, light emitting diodes, a liquid crystal display, a plasma display, or the like. Moreover, the display 124 may be a touchscreen that, in addition to providing optical information, detects the presence and location of a tactile input upon a surface of or adjacent to the display. Accordingly, each display may receive mechanical input directly upon the optical output provided by the display. Additionally, it is noted that the display 124 may include at least one of the one or more processors 202 and the one or memory modules 206. While the vehicle virtual assistance system 200 includes a display 124 in the embodiment depicted in FIG. 2, the vehicle virtual assistance system 200 may not include a display 124 in other embodiments, such as embodiments in which the vehicle virtual assistance system 200 audibly provides outback or feedback via the speaker 122.

As noted above, the vehicle virtual assistance system 200 includes the speaker 122 for transforming data signals from the vehicle virtual assistance system 200 into mechanical vibrations, such as in order to output audible prompts or audible information from the vehicle virtual assistance system 200. The speaker 122 is coupled to the communication path 204 and communicatively coupled to the one or more processors 202.

Still referring to FIG. 2, the vehicle virtual assistance system 200 comprises tactile input hardware 126a coupled to the communication path 204 such that the communication path 204 communicatively couples the tactile input hardware 126a to other modules of the vehicle virtual assistance system 200. The tactile input hardware 126a may be any device capable of transforming mechanical, optical, or electrical signals into a data signal capable of being transmitted with the communication path 204. Specifically, the tactile input hardware 126a may include any number of movable objects that each transform physical motion into a data signal that may be transmitted to over the communication path 204 such as, for example, a button, a switch, a knob, a microphone or the like. In some embodiments, the display 124 and the tactile input hardware 126a are combined as a single module and operate as an audio head unit or an infotainment system. However, it is noted that the display 124 and the tactile input hardware 126a may be separate from one another and operate as a single module by exchanging signals via the communication path 204. While the vehicle virtual assistance system 200 includes tactile input hardware 126a in the embodiment depicted in FIG. 2, the vehicle virtual assistance system 200 may not include tactile input hardware 126a in other embodiments, such as embodiments that do not include the display 124.

As noted above, the vehicle virtual assistance system 200 optionally comprises the peripheral tactile input 126b coupled to the communication path 204 such that the communication path 204 communicatively couples the peripheral tactile input 126b to other modules of the vehicle virtual assistance system 200. For example, in one embodiment, the peripheral tactile input 126b is located in a vehicle console to provide an additional location for receiving input. The peripheral tactile input 126b operates in a manner substantially similar to the tactile input hardware 126a, i.e., the peripheral tactile input 126b includes movable objects and transforms motion of the movable objects into a data signal that may be transmitted over the communication path 204.

As noted above, the vehicle virtual assistance system 200 comprises the microphone 120 for transforming acoustic vibrations received by the microphone into a speech input signal. The microphone 120 is coupled to the communication path 204 and communicatively coupled to the one or more processors 202. As will be described in further detail below, the one or more processors 202 may process the speech input signals received from the microphone 120 and/or extract speech information from such signals.

Still referring to FIG. 2, the vehicle virtual assistance system 200 comprises the activation switch 128 for activating or interacting with the vehicle virtual assistance system 200. In some embodiments, the activation switch 128 is an electrical switch that generates an activation signal when depressed, such as when the activation switch 128 is depressed by a user when the user desires to utilize or interact with the vehicle virtual assistance system 200. In some embodiments, the vehicle virtual assistance system 200 does not include the activation switch. Instead, when a user says a certain word, the vehicle virtual assistance system 200 becomes ready to recognize words spoken by the user.

As noted above, the vehicle virtual assistance system 200 comprises the microphone 120 for transforming acoustic vibrations received by the microphone into a speech input signal. The microphone 120 is coupled to the communication path 204 and communicatively coupled to the one or more processors 202. As will be described in further detail below, the one or more processors 202 may process the speech input signals received from the microphone 120 and/or extract speech information from such signals.

Still referring to FIG. 2, as noted above, the vehicle virtual assistance system 200 comprises the activation switch 128 for activating or interacting with the vehicle virtual assistance system 200. In some embodiments, the activation switch 128 is an electrical switch that generates an activation signal when depressed, such as when the activation switch 128 is depressed by a user when the user desires to utilize or interact with the vehicle virtual assistance system 200. In some embodiments, the vehicle virtual assistance system 200 does not include the activation switch. Instead, when a user says a certain word (e.g., “agent”), the vehicle virtual assistance system 200 becomes ready to recognize words spoken by the user.

As noted above, the vehicle virtual assistance system 200 includes the network interface hardware 218 for communicatively coupling the vehicle virtual assistance system 200 with a mobile device 220 or a computer network. The network interface hardware 218 is coupled to the communication path 204 such that the communication path 204 communicatively couples the network interface hardware 218 to other modules of the vehicle virtual assistance system 200. The network interface hardware 218 may be any device capable of transmitting and/or receiving data via a wireless network. Accordingly, the network interface hardware 218 may include a communication transceiver for sending and/or receiving data according to any wireless communication standard. For example, the network interface hardware 218 may include a chipset (e.g., antenna, processors, machine readable instructions, etc.) to communicate over wireless computer networks such as, for example, wireless fidelity (Wi-Fi), WiMax, Bluetooth, IrDA, Wireless USB, Z-Wave, ZigBee, or the like. In some embodiments, the network interface hardware 218 includes a Bluetooth transceiver that enables the vehicle virtual assistance system 200 to exchange information with the mobile device 220 (e.g., a smartphone) via Bluetooth communication.

Still referring to FIG. 2, data from various applications running on the mobile device 220 may be provided from the mobile device 220 to the vehicle virtual assistance system 200 via the network interface hardware 218. The mobile device 220 may be any device having hardware (e.g., chipsets, processors, memory, etc.) for communicatively coupling with the network interface hardware 218 and a cellular network 222. Specifically, the mobile device 220 may include an antenna for communicating over one or more of the wireless computer networks described above. Moreover, the mobile device 220 may include a mobile antenna for communicating with the cellular network 222. Accordingly, the mobile antenna may be configured to send and receive data according to a mobile telecommunication standard of any generation (e.g., 1G, 2G, 3G, 4G, 5G, etc.). Specific examples of the mobile device 220 include, but are not limited to, smart phones, tablet devices, e-readers, laptop computers, or the like.

The cellular network 222 generally includes a plurality of base stations that are configured to receive and transmit data according to mobile telecommunication standards. The base stations are further configured to receive and transmit data over wired systems such as public switched telephone network (PSTN) and backhaul networks. The cellular network 222 may further include any network accessible via the backhaul networks such as, for example, wide area networks, metropolitan area networks, the Internet, satellite networks, or the like. Thus, the base stations generally include one or more antennas, transceivers, and processors that execute machine readable instructions to exchange data over various wired and/or wireless networks.

Accordingly, the cellular network 222 may be utilized as a wireless access point by the network interface hardware 218 or the mobile device 220 to access one or more servers (e.g., a server 224). The server 224 generally includes processors, memory, and chipset for delivering resources via the cellular network 222. Resources may include providing, for example, processing, storage, software, and information from the server 224 to the vehicle virtual assistance system 200 via the cellular network 222.

Still referring to FIG. 2, the one or more servers accessible by the vehicle virtual assistance system 200 via the communication link of the mobile device 220 to the cellular network 222 may include third party servers that provide additional speech recognition capability. For example, the server 224 may include speech recognition algorithms capable of recognizing more words than the local speech recognition algorithms stored in the one or more memory modules 206. It should be understood that the network interface hardware 218 or the mobile device 220 may be communicatively coupled to any number of servers by way of the cellular network 222.

As noted above, the vehicle virtual assistance system 200 optionally includes a satellite antenna 230 coupled to the communication path 204 such that the communication path 204 communicatively couples the satellite antenna 230 to other modules of the vehicle virtual assistance system 200. The satellite antenna 230 is configured to receive signals from global positioning system satellites. Specifically, in one embodiment, the satellite antenna 230 includes one or more conductive elements that interact with electromagnetic signals transmitted by global positioning system satellites. The received signal is transformed into a data signal indicative of the location (e.g., latitude and longitude) of the satellite antenna 230 or an object positioned near the satellite antenna 230, by the one or more processors 202.

Additionally, it is noted that the satellite antenna 230 may include at least one of the one or more processors 202 and the one or memory modules 206. In embodiments where the vehicle virtual assistance system 200 is coupled to a vehicle, the one or more processors 202 execute machine readable instructions to transform the global positioning satellite signals received by the satellite antenna 230 into data indicative of the current location of the vehicle. While the vehicle virtual assistance system 200 includes the satellite antenna 230 in the embodiment depicted in FIG. 2, the vehicle virtual assistance system 200 may not include the satellite antenna 230 in other embodiments, such as embodiments in which the vehicle virtual assistance system 200 does not utilize global positioning satellite information or embodiments in which the vehicle virtual assistance system 200 obtains global positioning satellite information from the mobile device 220 via the network interface hardware 218.

Still referring to FIG. 2, it should be understood that the vehicle virtual assistance system 200 may be formed from a plurality of modular units, i.e., the display 124, the speaker 122, tactile input hardware 126a, the peripheral tactile input 126b, the microphone 120, the activation switch 128, etc. may be formed as modules that when communicatively coupled form the vehicle virtual assistance system 200. Accordingly, in some embodiments, each of the modules may include at least one of the one or more processors 202 and/or the one or more memory modules 206. Accordingly, it is noted that, while specific modules may be described herein as including a processor and/or a memory module, the embodiments described herein may be implemented with the processors and memory modules distributed throughout various communicatively coupled modules.

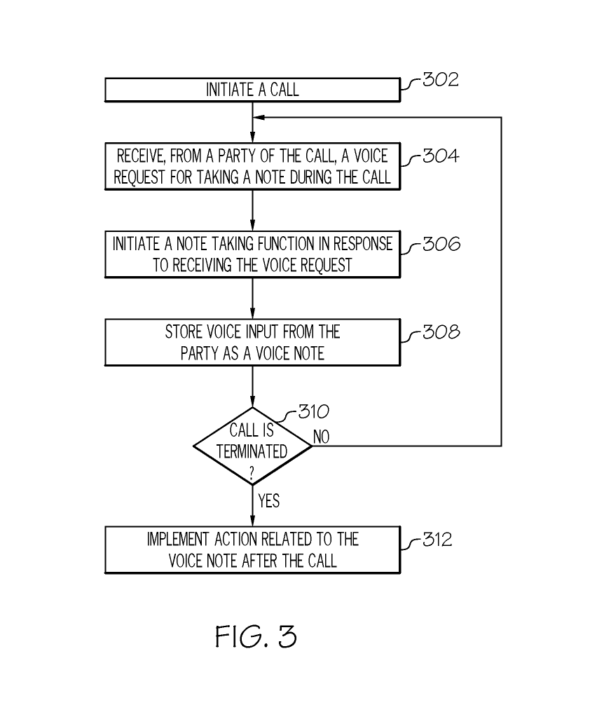

FIG. 3 depicts a flowchart for taking a note during a call. In block 302, the vehicle virtual assistance system 200 initiates a call. In embodiments, the vehicle virtual assistance system 200 receives an instruction from a user to place a call to a party. The vehicle virtual assistance system 200 may retrieve a call number for the party by looking up a phone number database stored in the one or more memory modules 206. As another example, the vehicle virtual assistance system 200 may retrieve a call number for the party by accessing a phone number database stored in the mobile device 220. In embodiments, the vehicle virtual assistance system 200 may initiate the call through the cellular network 222. In some embodiments, the vehicle virtual assistance system 200 may instruct the mobile device 220 to place the call.

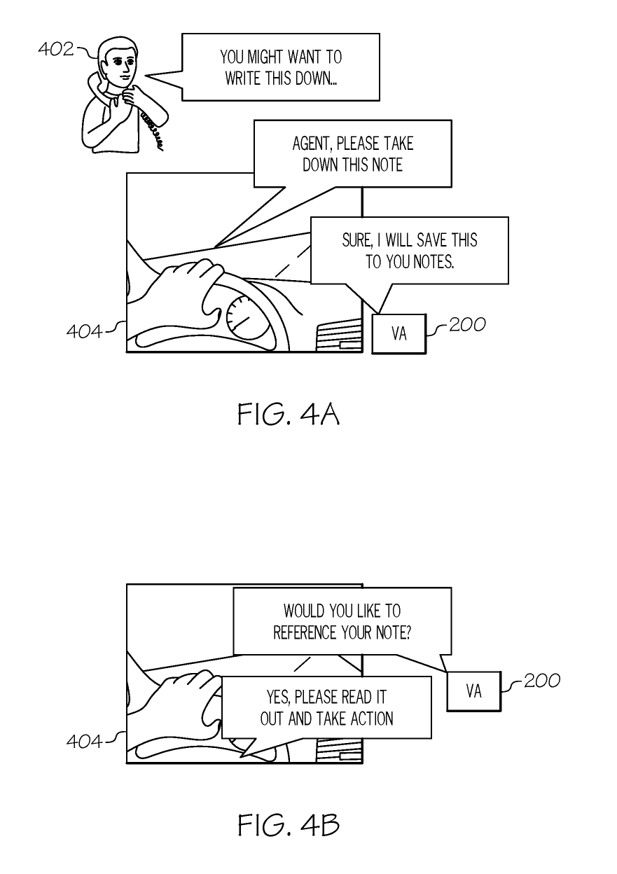

In block 304, the vehicle virtual assistance system 200 receives, from a party of the call, a voice request for taking a note during the call. In embodiments, as shown in FIG. 4A, the other party 402 of the call may say “You might want to write this down.” Then, the party 404 in the vehicle may make a statement for taking a note, for example, “Agent, please take down this note.” The voice input analysis logic 144a analyzes the vocal statement and interprets the statement as a request for taking a note. In some embodiments, the other party 402 instead of the party 404 may make a statement for taking a note to the vehicle virtual assistance system 200. For example, when the other party 402 makes a statement, for example “Agent, please take down this note,” that statement is output through the speaker 122. The voice input analysis logic 144a analyzes the statement output from the speaker 122 and interprets the statement as a request for taking a note. In some embodiments, both of the party 404 and the other party 402 may participate in taking notes. The vehicle virtual assistance system 200 may take notes from both the party 404 and the other party 402, respectively. The vehicle virtual assistance system 200 may consolidate the notes from the party 404 and the other party 402 into a single note.

In some embodiments, the party 404 in the vehicle may make a statement for taking a note for a certain topic. For example, the party 404 may make a statement “Agent, please take notes on this topic.” The voice input analysis logic 144a may interpret the statement, and start taking notes on the topic. As another example, the party 404 may make statement “Agent please take notes on Peter.” The voice input analysis logic 144a may analyze statements from any parties to determine whether the statement are related to Peter, and store statements that are related to Peter. For example, if the statement mentions Peter, then, the vehicle virtual assistance system 200 may store that statement as notes.

In block 306, the vehicle virtual assistance system 200 initiates a note taking function in response to receiving the voice request for taking a note. In embodiments, the vehicle virtual assistance system 200 starts recording a voice input from a party of the call that is received after the statement for taking a note in block 304. The response generation logic 144b may generate a statement, e.g., “Sure, I will save this to your notes,” and output the statement through the speaker 122, as shown in FIG. 4A.

In block 308, the vehicle virtual assistance system 200 stores voice input from the party as a note. In embodiments, the vehicle virtual assistance system 200 converts the voice input to text, and stores the converted text in the one or more memory modules 206. The vehicle virtual assistance system 200 may send the converted text to the mobile device 220 or to the server 224 through the cellular network 222. For example, the voice input analysis logic 144a may analyze the voice input from the party and convert the voice input into text and save the text in the one or more memory modules 206. In some embodiments, the vehicle virtual assistance system 200 may record the voice input from the party and store the voice input as an audio file in the one or more memory modules 206 or in the mobile device 220.

The vehicle virtual assistance system 200 may store additional information when storing the voice input as a voice note. For example, additional information includes context information, time, date, location, phone call participants, a title for the note, etc. Context information may include a person who requests for taking a note, a further action that needs to be taken, etc. The person who requests for taking a note may be determined based on call information. For example, if the other party 402 in FIG. 4A requested for taking a note, the vehicle virtual assistance system 200 may identify the other party 402 by looking up, from contact information in the one or more memory modules 206 or in the mobile device 220, the name associated with a call number that the party 404 reached. If the party 404 is the one who requested for taking a note, the vehicle virtual assistance system 200 may identify the party 404 by retrieving identification information from the mobile device 220 that the party 404 uses. The further action that needs to be taken may include action that needs to be taken based on a timing condition. For example, for the statement “Call John after this call,” or “Send an email to John at 7:30 pm,” the voice input analysis logic 144a may analyze the statement and identify “after the call” and “at 7:30 pm” as a timing condition.

The location information may include the location of the vehicle 102 when the note was taken. The location information may be obtained by the satellite antenna 230. The phone call participants may be determined based on caller identification and a call number as discussed above. The title for the note may be determined based on the context information, time, date, and/or phone call participants. For example, the vehicle virtual assistance system 200 may determine the title of the note as “Note taken while a call with John on October 31.”

In embodiments, a party who initiated the note-taking may terminate the note taking by making a statement that instructs termination of the note-taking. For example, when the party 404 makes a statement “Agent, stop note-taking,” the voice input analysis logic 144a interprets the statement and terminates the note-taking function.

In block 310, the vehicle virtual assistance system 200 determines whether a call is terminated. If the call is not terminated, the vehicle virtual assistance system 200 may continue to monitor whether the vehicle virtual assistance system 200 receives a voice request for taking a note during the call by returning to block 304.

In block 312, the vehicle virtual assistance system 200 implements action related to the voice note in response to determining that the call is terminated. In embodiments, the vehicle virtual assistance system 200 may output a statement related to the voice note. For example, the vehicle virtual assistance system 200 may ask if the party 404 wants to refer to the note taken during the call. The response generation logic 144b may generate a statement, e.g., “Would you like to reference to your note?” and the vehicle virtual assistance system 200 may output the statement through the speaker 122 as shown in FIG. 4B. Then, the vehicle virtual assistance system 200 may receive a vocal statement from the party 404 saying, e.g., “Yes, please read it out and take action,” as shown in FIG. 4B. The voice input analysis logic 144a interprets the vocal statement, and outputs the note through the speaker 122. In some embodiments, the vehicle virtual assistance system 200 may play the audio file for the note stored in the one or more memory modules 206, in the mobile device 220, or in the server 224 in response to determining that the call is terminated. In some embodiments, the vehicle virtual assistance system 200 may convert stored text into a speech and output the speech through the speaker 122. In some embodiments, the vehicle virtual assistance system 200 may display stored text related to the note on the display 124. A plurality of notes that had been taken during the call may be displayed on the display 124. The display 124 may show titles of the notes, and the party 404 in the vehicle may select one of the notes by manipulating the tactile input hardware 126a and/or peripheral tactile input 126b. Once one of the notes is selected, the full text of the note may be displayed on the screen, or voice of the full text of the note is output through the speaker 122.

In some embodiments, the vehicle virtual assistance system 200 may implement an action indicated in the voice note after the call is terminated. For example, if the voice note includes a statement “Call John after this call,” the vehicle virtual assistance system 200 may place a call to John in response to determining that the call is terminated. As another example, if the voice note includes a statement “Replay the note at 8:00 pm,” the vehicle virtual assistance system 200 may output the note through the speaker 122 or on the display 124 when it is 8:00 pm.

While the embodiments described above describe taking notes during a call, the vehicle virtual assistance system 200 may take notes prior to or after the call. In embodiments, prior a call, an occupant in a vehicle says, “Agent, please only take notes on the following topics . . . ” Then, the vehicle virtual assistance system 200 may listen for keywords in the conversation to begin taking notes. The voice input analysis logic 144a may continue to interpret keywords in the conversation and determine whether a subject is changed in the conversation. When the vehicle virtual assistance system 200 determines that the subject changes to another subject, the vehicle virtual assistance system 200 may termination note taking.

While the embodiments described above describe virtual assistance systems in vehicles, the virtual assistance system may be used in different settings. For example, the virtual assistance system may be used in a conference room where a plurality of people attends. The people in the conference room may have a talk with each other, and when they need to take notes, they may ask the virtual assistance system to take notes. More than one person may participate in taking notes using the virtual assistance system, and the virtual assistance system may combine the notes from multiple attendants.

It should be understood that embodiments described herein provide vehicle virtual assistance systems for taking notes. The vehicle virtual assistance system includes one or more processors, one or more memory modules communicatively coupled to the one or more processors, a microphone communicatively coupled to the one or more processors, wherein the microphone receives acoustic vibrations, and machine readable instructions stored in the one or more memory modules. The vehicle virtual assistance system initiates a call, receives, from a party of the call, a voice request for taking the note during the call, initiates a note taking function in response to receiving the voice request, and stores voice input from the party as a first note. When the call is terminated, the vehicle virtual assistance system reminds the party of the note, and takes action that is described in the note. With the help of the vehicle virtual assistance system, the user of the vehicle is able to take notes while she is on a call and driving in the vehicle. In addition, the other party of the call may also take notes for the user of the vehicle during the call. Furthermore, the vehicle virtual assistance system combines notes from more than one party of the call such that a party of the call is provided with a consolidated note for the call.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A vehicle virtual assistance system for taking a note, comprising:
one or more processors;
one or more memory modules;
a microphone communicatively coupled to the one or more processors, wherein the microphone receives acoustic vibrations; and
machine readable instructions stored in the one or more memory modules that cause the vehicle virtual assistance system to perform at least the following when executed by the one or more processors:
initiate a call;
receive, from a party of the call, a voice request and interpret the voice request as a request for taking the note during the call using speech recognition;
initiate a note taking function in response to interpreting the voice request as the request for taking the note;
store voice input from the party as a first note, the first note including an action and a timing condition;
determine whether the call is terminated;
determine whether the timing condition is met; and
implement the action in response to determining that the call is terminated and determining that the timing condition is met.

2. (canceled)

3. The vehicle virtual assistance system of claim 1, further comprising a speaker, wherein the machine readable instructions stored in the one or more memory modules cause the vehicle virtual assistance system to perform at least the following when executed by the one or more processors:
output, through the speaker, the first note in response to determining that the call terminated.

4. The vehicle virtual assistance system of claim 1, further comprising a display, wherein the machine readable instructions stored in the one or more memory modules cause the vehicle virtual assistance system to perform at least the following when executed by the one or more processors:
display, through the display, the first note in response to determining that the call terminated.

5. The vehicle virtual assistance system of claim 1, wherein the machine readable instructions stored in the one or more memory modules cause the vehicle virtual assistance system to perform at least the following when executed by the one or more processors:
convert the voice input into text; and
store the text as the first note.

6. The vehicle virtual assistance system of claim 1, wherein the machine readable instructions stored in the one or more memory modules cause the vehicle virtual assistance system to perform at least the following when executed by the one or more processors:
store the voice input as the first note along with additional information.

7. The vehicle virtual assistance system of claim 6, wherein the additional information includes at least one of time, data, or location of a vehicle.

8. The vehicle virtual assistance system of claim 6, wherein the additional information includes phone call participants.

9. The vehicle virtual assistance system of claim 8, wherein the machine readable instructions stored in the one or more memory modules cause the vehicle virtual assistance system to perform at least the following when executed by the one or more processors:
determine the phone call participants by looking up, from contact information stored in the one or more memory modules, a name associated with a call number of the call.

10. The vehicle virtual assistance system of claim 1, wherein the machine readable instructions stored in the one or more memory modules cause the vehicle virtual assistance system to perform at least the following when executed by the one or more processors:
receive, from another party of the call, a voice request for taking a note during the call;
initiate a note taking function in response to receiving the voice request from the another party; and
store voice input from the another party as a second note.

11. The vehicle virtual assistance system of claim 10, wherein the machine readable instructions stored in the one or more memory modules cause the vehicle virtual assistance system to perform at least the following when executed by the one or more processors:
combine the first note and the second note.

12. (canceled)

13. (canceled)

14. A vehicle comprising:
a microphone configured to receive acoustic vibrations; and
a vehicle virtual assistance system communicatively coupled to the microphone, comprising:
one or more processors;
one or more memory modules; and
machine readable instructions stored in the one or more memory modules that cause the vehicle virtual assistance system to perform at least the following when executed by the one or more processors:
initiate a call;
receive, from a party of the call, a voice request and interpret the voice request as a request for taking a note during the call using speech recognition;
initiate a note taking function in response to interpreting the voice request as the request for taking the note;
store voice input from the party as a first note, the first note including an action and a timing condition;
determine whether the call is terminated;
determine whether the timing condition is met; and
implement the action in response to determining that the call is terminated and determining that the timing condition is met.

15. The vehicle of claim 14, wherein the machine readable instructions stored in the one or more memory modules cause the vehicle virtual assistance system to perform at least the following when executed by the one or more processors:
determine whether the call terminated; and
implement action related to the first note in response to determining that the call terminated.

16. The vehicle of claim 14, wherein the machine readable instructions stored in the one or more memory modules cause the vehicle virtual assistance system to perform at least the following when executed by the one or more processors:
store the voice input as the first note along with additional information.

17. The vehicle of claim 16, wherein the additional information includes at least one of time, data, location of the vehicle, or phone call participants.

18. The vehicle of claim 14, wherein the machine readable instructions stored in the one or more memory modules cause the vehicle virtual assistance system to perform at least the following when executed by the one or more processors:
receive, from another party of the call, a voice request for taking a note during the call;
initiate a note taking function in response to receiving the voice request from the another party; and
store voice input from the another party as a second note.

19. The vehicle of claim 14, wherein the machine readable instructions stored in the one or more memory modules cause the vehicle virtual assistance system to perform at least the following when executed by the one or more processors:
receive, from the party of the call, a request for a reminder during the call, wherein the request for the reminder includes an action that needs to be taken according to a timing condition.

20. A method for taking notes, the method comprising:
initiating a call;
receiving, through a microphone of a vehicle virtual assistance system, a voice request and interpreting the voice request as a request for taking notes during the call from a party of the call using speech recognition;
initiating a note taking function of the virtual assistance system in response to interpreting the voice request as the request for taking notes;
receiving voice input from the party of the call;
storing the voice input as a note, the first note including an action and a timing condition;
determining that the call is terminated;
determining that the timing condition is met; and
implementing the action in response to determining that the call is terminated and determining that the timing condition is met.
